(19) United States
(12) Patent Application Publication
(10) Pub. No.: US 2024/0393178 A1
(43) Pub. Date: Nov. 28, 2024

(54) METHOD FOR CALIBRATING A SPECTROMETER DEVICE

(71) Applicant: TRINAMIX GMBH, Ludwigshafen Am Rhein (DE)

(72) Inventor: Robert LOVRINCIC, Ludwigshafen am Rhein (DE)

(21) Appl. No.: 18/693,003

(22) PCT Filed: Oct. 18, 2022
(86) PCT No.: PCT/EP2022/078903

§ 371 Date: Mar. 18, 2024

(30) Foreign Application Priority Data
Oct. 19, 2021 (EP) 21203363.3

(51) Int. Cl. G01J 3/28; G01J 3/06; G01J 3/453

(52) U.S. Cl. CPC G01J 3/2803; G01J 3/06; G01J 3/4535; G01J 2003/064; G01J 2003/2879; G01J 2003/4538

(57) ABSTRACT

Disclosed herein is a method for calibrating a spectrometer device. The spectrometer device includes at least one detector device including at least one optical element configured for separating incident light into a spectrum of constituent wavelength components and further includes a plurality of photosensitive elements. The method includes the following steps:
a) illuminating, by using at least one broadband light source, the spectrometer device through at least one optical interferometer;
b) determining for the plurality of photosensitive elements a plurality of detectors signals depending on the illumination through the optical interferometer in step a); and
c) determining at least one item of calibration information from the plurality of detector signals.

Further disclosed herein are a system for calibrating a spectrometer device, a computer program and a computer-readable storage medium for performing the method.

### TECHNICAL FIELD

The present invention relates to a method and a system for calibrating a spectrometer device. Further, the present invention relates to a computer program and a computer-readable storage medium for performing the method for calibrating a spectrometer device. The method and devices can, in particular, be used for calibrating spectrometer devices used for investigation in the infrared spectral region, specifically in the near infrared and the mid infrared spectral regions. However, other spectrometer devices used for optical investigation are also feasible.

### BACKGROUND ART

Spectrographic methods are widely used in research, industry and customer applications, enabling multiple applications such as optical analysis and/or quality control. Use cases can be found for food, farming, pharma, medical, life sciences and many more. Various methods are available, such as photometry, absorption, fluorescence and Raman spectrometry, enabling qualitative and/or quantitative sample analysis. These methods usually involve mapping of spectral information, such as an irradiance of a sample, at a specific wavelength onto a specific physical section of the spectrographic device, for example detector pixels, time intervals or others.

Generally, spectrographic methods require for a successful application reliable performance of the spectrographic devices having negligible fluctuation, in particular when comparing measurements from various spectrographic devices with each other. Specifically, spectral data for a specific sample should be at least similar or identical for various spectrographic devices of the same type.

For spectrographic devices, a calibration in terms of wavelength and/or stray light may generally be crucial for a reliable performance. Specifically, some spectrographic devices may use gratings and/or filters, such as bandpass filters, as part of an optical sensor to select which part of the spectrum is detected by a certain detector element. Detailed information of the grating and/or filter, such as bandwidth and/or out of band blocking, and its interplay with the detector elements may generally be required for understanding a response of the optical sensor. For example, when placing a linear variable filter on a linear array of a plurality of detector elements or pixels to build the optical sensor, a wavelength calibration of the optical sensor may generally be necessary.

Various methods for wavelength and/or stray light calibrations are known in the art. For example, the optical sensor may be illuminated with monochromatic light of a certain wavelength. The illumination may be detected by a certain detector element of the linear array. As the wavelength of the monochromatic light is known, the optical sensor may be calibrated. Furthermore, information on a spectral resolution of the optical sensor may be obtained in this way.

As an example, a method to correct a spectroradiometer's response for measurement errors arising from the instrument's spectral stray light is described in Y. Zong, S. W. Brown, B. C. Johnson, K. R. Lykke and Y. Ohno: “Simple spectral stray light correction method for array spectroradiometers”, Applied Optics, volume 45, number 6, 2006. By characterizing the instrument's response to a set of monochromatic laser sources that cover the instrument's spectral range, one obtains a spectral stray light signal distribution matrix that quantifies the magnitude of the spectral stray light signal within the instrument. By use of these data, a spectral stray light correction matrix is derived and the instrument's response can be corrected with a simple matrix multiplication.

US 2011/032529 A1 discloses a calibration of an arbitrary spectrometer using a stable monolithic interferometer as a wavelength calibration standard. Light from a polychromatic light source is input to the monolithic interferometer where it undergoes interference based on the optical path difference of the interferometer. The resulting wavelength-modulated output beam is analyzed by a reference spectrometer to generate reference data. The output beam from the interferometer can be provided to an arbitrary spectral instrument. Wavelength calibration of the arbitrary spectral instrument may then be performed based on a comparison of the spectral instrument output with the reference data.

WO 2003/085371 A2 discloses a method and a system for real time high speed high resolution hyper-spectral imaging. The system comprises an electromagnetic radiation collimating element, for collimating electromagnetic radiation emitted by objects in a scene or a sample. The system comprises an optical interferometer, for receiving and dividing collimated object emission beam, for generating interference images, and for piezoelectrically determining and changing magnitude of optical path difference of divided collimated object emission beam. The optical interferometer includes: a beam splitter; a fixed mirror; a movable mirror; a piezoelectric motor, for displacing the movable mirror along an axis; a distance change feedback sensor, for sensing and measuring change in distance of movable mirror along the axis; a piezoelectric motor controller, for actuating and controlling the piezoelectric motor; and a thermo-mechanically stable optical interferometer mount. The system further comprises camera optics, for focusing interference images of each optical path difference; a detector, for recording interference images; a central programming and signal processing unit, and a display.

Despite the advantages achieved by known method and devices, several technical challenges remain. Specifically, each wavelength may have to be calibrated individually. Such a procedure may be time consuming and expensive as monochromatic light of different wavelengths is required. Alternatively, only a few wavelengths may be used for calibration and signals for detector elements in between may be interpolated. However, the interpolation may limit an amount of information obtained on the optical sensor.

### Problem to be Solved

It is therefore desirable to provide methods and devices which at least partially address above-mentioned technical challenges regarding the calibration of spectrometer devices. Specifically, a method and a system for calibrating a spectrometer device shall be proposed which provide a time and cost effective calibration while increasing an amount of calibration information.

### SUMMARY

This problem is addressed by a method and a system for calibrating a spectrometer device, by a computer program and a computer-readable storage medium with the features of the independent claims. Advantageous embodiments which might be realized in an isolated fashion or in any arbitrary combinations are listed in the dependent claims as well as throughout the specification.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, a method for calibrating a spectrometer device is disclosed, such as a detector of the spectrometer device.

The term “spectrometer device” as used herein is a broad term and is to be given its ordinary and customary meaning to a person of ordinary skill in the art and is not to be limited to a special or customized meaning. The term specifically may refer, without limitation, to a device capable of optically analyzing at least one sample, thereby generating at least one item of information on at least one spectral property of the sample. Specifically, the term may refer to a device which is capable of recording a signal intensity with respect to a corresponding wavelength of a spectrum or a partition thereof, such as a wavelength interval, wherein the signal intensity may, preferably, be provided as an electrical signal which may be used for further evaluation. An optical element, specifically comprising at least one wavelength-selective element, such as an optical filter and/or a dispersive element, may be used for separating incident light into a spectrum of constituent wavelength components whose respective intensities are determined by employing a detector device. In addition, a further optical element may be used which can be designed for receiving incident light and transferring the incident light to the optical element. The spectrometer device, generally, may be operable in a reflective mode and/or may be operable in a transmissive mode. For possible embodiment of the spectrometer device, reference is made to the description of the spectrometer device as will be outlined in further detail below.

The term “calibrating”, the process also being referred to as “calibration”, as used herein is a broad term and is to be given its ordinary and customary meaning to a person of ordinary skill in the art and is not to be limited to a special or customized meaning. The term specifically may refer, without limitation, to a process of at least one of determining, correcting and adjusting measurement inaccuracies at the spectrometer device. Thus, the result of the calibration process, often also referred to as the “item of calibration information”, may also be or comprise at least one item of information on the result of the calibration process, such as a calibration function, a calibration factor, a calibration matrix or the like, e.g. for transforming one or more measured values into one or more calibrated or “true” values. Measurement inaccuracies may, as an example, arise from uncertainties in wavelength determination and/or from intrinsic and/or extrinsic interferences on measurement signals of the spectrometer device. Thus, calibrating the spectrometer device may comprise at least one of a wavelength calibration, a stray light calibration, a dark current calibration, a test of a spectral resolution. The calibration, specifically each of the calibrations, may comprise at least one two-step process, wherein, in a first step, information on a deviation of a measurement signal of the spectrometer device from a known standard is determined, wherein, in a second step, this information is used for correcting and/or adjusting the measurement signal of the spectrometer device in order to reduce, minimize and/or eliminate the deviation. Thus, the calibration may comprise applying the item of calibration information, for example to a measurement signal and/or to a measurement spectrum of the spectrometer device. A calibration of the spectrometer device may improve and/or maintain accuracy of measurements performed with the calibrated spectrometer device.

The calibrating of the spectrometer device specifically may be performed at a manufacturer's site of the spectrometer device manufacturer. The calibrating, however, may also be performed in the field, such as after setup of the spectrometer device at the site of use and/or for maintenance purposes.

The spectrometer device comprises at least one detector device. Thus, specifically, when calibrating the spectrometer device, a calibration of the detector device comprised by the spectrometer device may be necessary and may be performed. The term “detector device” as used herein is a broad term and is to be given its ordinary and customary meaning to a person of ordinary skill in the art and is not to be limited to a special or customized meaning. The term specifically may refer, without limitation, to an arbitrary device or combination of devices capable of recording and/or monitoring incident light. The detector device may be responsive to incident illumination and may be configured for generating an electrical signal indicating an intensity of the illumination. The detector device may be sensitive in one or more of a visible spectral range, an ultraviolet spectral range or the infrared spectral range, specifically a near infrared spectral range (NIR). The detector device specifically may be or may comprise at least one optical sensor, e.g. an optical semiconductor sensor. As an example, specifically in case the detector device is sensitive in the infrared spectral range, such as in the near infrared spectral range, the semiconductor sensor may be or may comprise at least one semiconductor sensor comprising at least one material selected from the group consisting of Si, PbS, PbSe, InGaAs, and extended-InGaAs. As an example, the detector device may comprise at least one photodetector such as at least one CCD or CMOS device. The detector device specifically may comprise at least one detector array comprising a plurality of pixelated sensors, wherein each of the pixelated sensors is configured to detect at least a portion of at least one of the constituent wavelength components.

The detector device comprises at least one optical element configured for separating incident light into a spectrum of constituent wavelength components. The term “optical element” as used herein is a broad term and is to be given its ordinary and customary meaning to a person of ordinary skill in the art and is not to be limited to a special or customized meaning. The term specifically may refer, without limitation, to an arbitrary element or a combination of elements suitable for one or more of transmitting, reflecting, deflecting or scattering light in a wavelength-dependent manner. The optical element may further be configured, specifically after separating incident light into the spectrum of constituent wavelength components, for transmitting the spectrum onto the detector device. Specifically, the wavelength-dependent transmission, reflections, deflection or scattering of incident light at the optical element may result in a spatial separation of the constituent wavelength components of the spectrum and, thus, may be transmitted directly or indirectly onto the detector device.

The term “light” as used herein is a broad term and is to be given its ordinary and customary meaning to a person of ordinary skill in the art and is not to be limited to a special or customized meaning. The term specifically may refer, without limitation, to a partition of electromagnetic radiation which is, usually, referred to as “optical spectral range” and which comprises one or more of a visible spectral range, an ultraviolet spectral range and an infrared spectral range. The terms “ultraviolet spectral” or “UV”, generally, refer to electromagnetic radiation having a wavelength of 1 nm to 380 nm, preferably of 100 nm to 380 nm. The term “visible”, generally, refers to a wavelength of 380 nm to 760 nm. The terms “infrared” or “IR”, generally, refer to a wavelength of 760 nm to 1000 μm, wherein a wavelength of 760 nm to 3 μm is, usually, denominated as “near infrared” or “NIR” while the wavelength of 3 u to 15 μm is, usually, denoted as “mid infrared” or “MidIR” and the wavelength of 15 μm to 1000 μm as “far infrared” or “FIR”.

The term “spectrum” as used herein is a broad term and is to be given its ordinary and customary meaning to a person of ordinary skill in the art and is not to be limited to a special or customized meaning. The term specifically may refer, without limitation, to a partition of the optical spectral range, in particular, the IR spectral range, especially at least one of the NIR or the MidIR spectral ranges, being investigated by the spectrometer device. Each part of the spectrum may be constituted by an optical signal which is defined by a signal wavelength and the corresponding signal intensity. Consequently, the term “constituent wavelength component” as used herein is a broad term and is to be given its ordinary and customary meaning to a person of ordinary skill in the art and is not to be limited to a special or customized meaning. The term specifically may refer, without limitation, to the optical signal forming part of the spectrum. Specifically, the optical signal may comprise the signal intensity corresponding to the respective wavelength or wavelength interval.

The detector device further comprises a plurality of photosensitive elements, wherein each photosensitive element is configured for receiving at least a portion of one of the constituent wavelength components and for generating a respective detector signal depending on an illumination of the respective photosensitive element by the at least one portion of the respective constituent wavelength component.

The term “photosensitive element” as used herein is a broad term and is to be given its ordinary and customary meaning to a person of ordinary skill in the art and is not to be limited to a special or customized meaning. The term specifically may refer, without limitation, to an individual optical sensor comprised by the detector device, wherein each optical sensor has at least one photosensitive area configured for recording a photoresponse of the photosensitive element by generating at least one output signal that depends on an intensity of a portion of one of the constituent wavelength components impinging on the particular photosensitive area. The at least one photosensitive area as comprised by each individual optical sensor may, especially, be a single, uniform area which is designated for receiving incident light impinging on the photosensitive area. The at least one output signal may, in particular, be used as the detector signal and can, preferably, be provided to an external evaluation unit for further evaluation.

Consequently, the term “detector signal” as used herein is a broad term and is to be given its ordinary and customary meaning to a person of ordinary skill in the art and is not to be limited to a special or customized meaning. The term specifically may refer, without limitation, to a signal generated by at least one detector, specifically to the at least one output signal of the photosensitive element. The at least one output signal may be selected from at least one of an electronic signal and an optical signal. The at least one output signal may be an analogue signal and/or a digital signal. The output signals for adjacent photosensitive elements can be generated simultaneously, or in a temporally successive manner. By way of example, during a row scan or a line scan, it can be feasible to generate a sequence of output signals which correspond to the series of the photosensitive elements which may be arranged in a line. In addition, the individual photosensitive elements may, preferably, be active pixel sensors which may be adapted to amplify the output signals prior to providing them as detector signals to an external evaluation unit. For this purpose, the photosensitive element may comprise one or more signal processing devices, such as one or more filters and/or analogue-digital-converters for processing and/or preprocessing the electronic signals.

The method comprises the following steps which, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises the following steps:
a) illuminating, by using at least one broadband light source, the spectrometer device, specifically the detector device, through at least one optical interferometer;
b) determining for the plurality of photosensitive elements, specifically for each of the photosensitive elements, a plurality of detectors signals depending on the illumination through the optical interferometer in step a); and
c) determining at least one item of calibration information from the plurality of detector signals.

The term “illuminating” as used herein is a broad term and is to be given its ordinary and customary meaning to a person of ordinary skill in the art and is not to be limited to a special or customized meaning. The term specifically may refer, without limitation, to a process of providing, passing and/or guiding light from a light source to a device or element to be illuminated. Specifically, illuminating a device or an element by using the broadband light source may comprise providing and/or guiding the light emitted from the broadband light source to the device or element to be illuminated. On a path of the light from the broadband light source to the device or element to be illuminated, one or more further devices may be arranged. Thus, illuminating the device or element to be illuminated through the one or more further devices may comprise guiding the light from the broadband light source to the one or more further devices and subsequently providing and/or guiding the light to the device or element to be illuminated. For example, illuminating the spectrometer device, specifically the detector device, through the optical interferometer may comprise guiding the light from the broadband light source to the optical interferometer and subsequently guiding the light which passed through the optical interferometer to the spectrometer device, specifically to the detector device.

The term “broadband light source” as used herein is a broad term and is to be given its ordinary and customary meaning to a person of ordinary skill in the art and is not to be limited to a special or customized meaning. The term specifically may refer, without limitation, to a device emitting light in a broad spectral range, such as light having a spectral width of at least 5 nm, specifically at least 10 nm, e.g. a spectral width of 10 nm to 3000 nm. The broad spectral range of the broadband light source may comprise at least one of the visible spectral range, the ultraviolet spectral range and the infrared spectral range. Light used for the typical purposes of the present invention may, in particular, comprise light in the IR spectral range, specifically in at least one of the NIR or the MidIR spectral ranges, more specifically having a wavelength of 1 μm to 5 μm, even more specifically of 1 μm to 3 μm. For example the broadband light source may comprise a thermal emitter emitting light in the NIR and in the MidIR, such as from 1000 nm to 3000 nm, more specifically from 1300 nm to 2500 nm. Further possible embodiments of the broadband light source are described in further detail below.

The term “optical interferometer” as used herein is a broad term and is to be given its ordinary and customary meaning to a person of ordinary skill in the art and is not to be limited to a special or customized meaning. The term specifically may refer, without limitation, to a device or a combination of devices for enabling superposition of light, specifically of light in the optical spectral range, to cause an effect of interference of the superimposed light. For example, the optical interferometer may be configured for splitting incident light into at least two beams of light and, further, for causing a phase shift of the split light beams relative to each other. The optical interferometer may further be configured for combining the phase shifted light beams such that the light beams superimpose and interfere with each other.

The optical interferometer specifically may be selected from the group consisting of: a Michelson interferometer; a Fabry-Pérot interferometer; a cube corner interferometer. However, other optical interferometers are also feasible.

Further, in step a), a transmission frequency of the optical interferometer may be varied over a predetermined spectral range, and wherein, in step b), the plurality of detectors signals may be determined depending on the transmission frequency of the optical interferometer. In step c), the at least one item of calibration information may be determined by comparing the transmission frequency of the optical interferometer with at least one of a pixel position and an identification number of the plurality of photosensitive elements generating intensity peaks in the plurality of detector signals associated with the transmission frequency. The term “transmission frequency” as used herein is a broad term and is to be given its ordinary and customary meaning to a person of ordinary skill in the art and is not to be limited to a special or customized meaning. The term specifically may refer, without limitation, to a main frequency of a spectrum of a plurality of frequencies transmitted through the optical spectrometer. Specifically, the transmission frequency of the optical interferometer may refer to the main frequency in the spectrum of transmitted frequencies having the highest transmitted intensity. The transmission frequency may be used as a reference for calibrating the optical interferometer. The term “pixel position” as used herein is a broad term and is to be given its ordinary and customary meaning to a person of ordinary skill in the art and is not to be limited to a special or customized meaning. The term specifically may refer, without limitation, to an arbitrary item of location information of the photosensitive element in the detector device. The pixel information may describe a position of the photosensitive element in the detector device by using one or more of an absolute position information and a relative position information, specifically in one, two or even three dimensions. The term “identification number” as used herein is a broad term and is to be given its ordinary and customary meaning to a person of ordinary skill in the art and is not to be limited to a special or customized meaning. The term specifically may refer, without limitation, to a numerical or alpha-numerical item of information uniquely identifying each photosensitive element comprised by the detector device. For example, the photosensitive elements of the detector device may be numbered with respect to an order of appearance in the detector device. However, other options for identifying the photosensitive elements in the detector device are also feasible.

The plurality of detector signals may be recorded for a wavenumber in the range from 12.000 1/cm to 500 1/cm, specifically in the range from 10.000 1/cm to 1000 1/cm, more specifically in the range from 7.000 1/cm to 4.000 1/cm. Thus, the optical spectrometer device may be configured for transmitting light having a wavenumber in the range from 12.000 1/cm to 500 1/cm, specifically in the range from 10.000 1/cm to 1000 1/cm, more specifically in the range from 7.000 1/cm to 4.000 1/cm.

The optical interferometer may, as an example, comprise at least one beam splitting device for splitting incident light, specifically incident light from the broadband light source, into at least two illumination paths. The optical interferometer may further comprise at least one scanning mirror in a first illumination path and at least one stationary mirror in a second illumination path. In the method, specifically in step a), the scanning mirror may be moved along the first illumination path, wherein the stationary mirror may be kept stationary. The scanning mirror may be moved in a stepwise manner with a stepping frequency of 1 kHz or less, specifically with a stepping frequency of 500 Hz or less, more specifically with a stepping frequency of 150 Hz or less. Specifically, the stepping frequency of the scanning mirror may be slower than a maximum readout frequency of the detector device. For example, if the maximum readout frequency of the detector device limits the stepping frequency to 1 kHz or less, a stepping frequency of 100 Hz may be optimal. The term “readout frequency” as used herein is a broad term and is to be given its ordinary and customary meaning to a person of ordinary skill in the art and is not to be limited to a special or customized meaning. The term specifically may refer, without limitation, to a quantitative measure of readouts being performed in a specific time interval. Specifically, in the detector device, the output signal of the photosensitive elements may be generated by associated signal processing devices, such as readout integrated circuits. For example, each photosensitive element may comprise a readout integrated circuit, wherein the readout integrated circuit may be configured for accumulating a photoresponse, specifically a photocurrent, of the photosensitive element generated in response to illumination of the photosensitive element and for transferring the accumulated photoresponse for further signal processing. The readout frequency may be indicative of a time interval in which the photocurrent of the photosensitive element is accumulated by the readout integrated circuit. The term “stepping frequency” as used herein is a broad term and is to be given its ordinary and customary meaning to a person of ordinary skill in the art and is not to be limited to a special or customized meaning. The term specifically may refer, without limitation, to a quantitative measure of steps performed in a specific time interval. Specifically, the stepping frequency of the scanning mirror may quantify a number of steps or positions of the scanning mirror in the first illumination path per second.

Further, in step b), the plurality of detector signals may be determined for a plurality of positions of the scanning mirror in the first illumination path. The plurality of positions of the scanning mirror may be different from each other. Additionally, step c) may comprise, specifically prior to processing the plurality of detector signals, correlating the plurality of detector signals with the plurality of positions of the scanning mirror. Thus, in step c), the plurality of detector signals correlated to the plurality of positions of the scanning mirror may be used for determining the at least one item of calibration information.

Additionally or alternatively, step c) may comprise processing the plurality of detector signals determined in the step b), thereby obtaining a plurality of processed detector signals. The determining of the at least one item of calibration information in step c) may comprise determining the at least one item of calibration information from the plurality of processed detector signals. The term “processing”, as used herein, may specifically refer to a process of performing one or more operations with the plurality of detector signals. The result of the processing may be or may comprise the plurality of processed detector signals. Specifically, the processing of the plurality of detector signals may comprise transforming, specifically mathematically transforming, the plurality of detector signals. For example, the plurality of detector signals may be transformed by using at least one Fourier transformation, specifically at least one discrete Fourier transformation. Additionally or alternatively, the processing may comprise applying one or more of an offset correction and a digital filter to the plurality of detector signals.

As outlined above, step c) comprises determining the at least one item of calibration information. The item of calibration information may comprise at least one of an item of wavelength calibration information and an item of stray light calibration information. The item of wavelength calibration information may comprise at least one wavelength calibration function. The wavelength calibration function may assign at least one of the pixel position and the identification number of the photosensitive elements to a wavelength position. For example, the wavelength calibration function may comprise a polynomial function. However, other wavelength calibration functions are also feasible. The item of stray light calibration information may comprise at least one signal distribution function, specifically at least one signal distribution matrix. The signal distribution function may describe a distribution of responses of the plurality of photosensitive elements, specifically a distribution of response of each photosensitive element, to incident light having a specific wavelength. By way of example, computation and/or application of the signal distribution matrix may be described in further detail in Y. Zong, S. W. Brown, B. C. Johnson, K. R. Lykke and Y. Ohno: “Simple spectral stray light correction method for array spectroradiometers”, Applied Optics, volume 45, number 6, 2006.

Additionally or alternatively, the method, specifically step c), may be at least partially computer-implemented, as will be outlined in further detail below.

In a further aspect of the present invention, a system for calibrating a spectrometer device is disclosed. The system comprises the spectrometer device comprising at least one detector device, wherein the detector device comprises at least one optical element configured for separating incident light into a spectrum of constituent wavelength components and further comprising a plurality of photosensitive elements, wherein each photosensitive element is configured for receiving at least a portion of one of the constituent wavelength components and for generating a respective detector signal depending on an illumination of the respective photosensitive element by the at least one portion of the respective constituent wavelength component. The system further comprises at least one broadband light source and at least one optical interferometer arranged to illuminate the spectrometer device, specifically the detector device, with the broadband light source through the optical interferometer. The system further comprises at least one evaluation unit, wherein the evaluation unit is configured for performing the method according to the present invention, such as according to any one of the embodiments disclosed above and/or any one of the embodiments disclosed in further detail below.

For definitions and possible embodiments of the system or parts thereof, reference is made to the definitions and embodiments as described with respect to the method for calibrating a spectrometer device.

The term “evaluation unit” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. In particular, the evaluation unit may be configured for processing basic instructions that drive the computer or system. As an example, the evaluation unit may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. In particular, the processor may be a multi-core processor. Specifically, the evaluation unit may be or may comprise a central processing unit (CPU). For example, the evaluation unit may comprise one or more processors. Additionally or alternatively, the evaluation unit may be or may comprise a microprocessor, thus specifically the evaluation unit's elements may be contained in one single integrated circuitry (IC) chip. Additionally or alternatively, the evaluation unit may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The evaluation unit may specifically be configured, such as by software programming, for performing one or more evaluation operations, specifically one or more operations performed in step c) of the method as described in further detail above. The evaluation unit may be configured for, unidirectionally and/or bidirectionally, exchanging data and/or control commands with other elements of the system, specifically with the detector device. Specifically, the evaluation unit may be configured for receiving the plurality of detector signals from the detector device.

The broadband light source may, as an example, comprise at least one of: an incandescent lamp; a blackbody radiator; an electric filament; a light emitting diode.

The optical element may comprise at least one wavelength selective element. The wavelength selective element may be selected from the group consisting of: a prism; a grating; a linear variable filter; an optical filter, specifically a narrow band pass filter.

The detector device may comprise the plurality of photosensitive elements arranged in a linear array. The linear array of photosensitive elements may comprise a number of 10 to 1000 photosensitive elements, specifically a number of 100 to 500 photosensitive elements, specifically a number of 200 to 300 photosensitive elements, more specifically a number of 256 photosensitive elements. Each photosensitive element may be selected from the group consisting of: a pixelated inorganic camera element, specifically a pixelated inorganic camera chip, more specifically a CCD chip or a CMOS chip; a monochrome camera element, specifically a monochrome camera chip; at least one photoconductor, specifically an inorganic photoconductor, more specifically an inorganic photoconductor comprising PbS, PbSe, Ge, InGaAs, ext. InGaAs, InSb or HgCdTe. Each photosensitive element may be sensitive for electromagnetic radiation in wavelength range from 760 nm to 1000 μm, specifically in a wavelength range from 760 nm to 15 μm, more specifically in a wavelength range from 1 μm to 5 μm, more specifically in a wavelength range from 1 μm to 3 μm.

The detector device may specifically be comprised by the spectrometer device, specifically by at least one of a reflection spectrometer device and a transmission spectrometer device.

In a further aspect of the present invention, a computer program is disclosed comprising instructions which, when the program is executed by the system according to the present invention, such as according to any one of the embodiments disclosed above and/or any one of the embodiments disclosed in further detail below, cause the evaluation unit of the system to perform the method for calibrating a spectrometer device according to the present invention, such as according to any one of the embodiments disclosed above and/or any one of the embodiments disclosed in further detail below.

Thus, specifically, at least method step c) as indicated above may be performed by using a computer or a computer network, preferably by using a computer program. However, one, more than one or even all of method steps a) to c) as indicated above may be at least computer controlled and/or supported by a computer or a computer network.

In a further aspect of the present invention, a computer-readable storage medium is disclosed comprising instructions which, when the program is executed by the system according to the present invention, such as according to any one of the embodiments disclosed above and/or any one of the embodiments disclosed in further detail below, cause the evaluation unit of the system to perform the method for calibrating a spectrometer device according to the present invention, such as according to any one of the embodiments disclosed above and/or any one of the embodiments disclosed in further detail below.

As used herein, the term “computer-readable storage medium” specifically may refer to nontransitory data storage means, such as a hardware storage medium having stored thereon computer-executable instructions. The computer-readable storage medium, also referred to as computer-readable data carrier, specifically may be or may comprise a storage medium such as a random-access memory (RAM) and/or a read-only memory (ROM).

The method and system according to the present invention may provide a large number of advantages over known methods and devices. Specifically, by combining the spectrometer device, specifically comprising the detector device having a linear variable filter as the optical element, with the optical interferometer, the calibration of the spectrometer device may be improved. The method and the system may allow for a faster calibration of the spectrometer device while also increasing an amount of measured information, such as information on spectral resolution and stray light. Specifically, the need for separately calibrating each wavelength using monochromatic laser sources and/or a plurality of different band pass filter may be obsolete by performing the method according to the present invention.

In the method, broadband light may be emitted from the broadband light source, may be passed through the optical interferometer and may be guided to the spectrometer device, specifically to the detector device. The plurality of photosensitive elements of the detector device, specifically all of the plurality of photosensitive elements, may be read out with suitable electronics. The plurality of detector signals as a function of time I(t) may be correlated to the movement of the scanning mirror in the optical interferometer. A Fourier transformation may be used to obtain a full transmission spectrum of the optical element for each photosensitive element comprised by the detector device.

Summarizing and without excluding further possible embodiments, the following embodiments may be envisaged:

Embodiment 1: A method for calibrating a spectrometer device, wherein the spectrometer device comprises at least one detector device comprising at least one optical element configured for separating incident light into a spectrum of constituent wavelength components and further comprising a plurality of photosensitive elements, wherein each photosensitive element is configured for receiving at least a portion of one of the constituent wavelength components and for generating a respective detector signal depending on an illumination of the respective photosensitive element by the at least one portion of the respective constituent wavelength component, wherein the method comprises the following steps:
a) illuminating, by using at least one broadband light source, the spectrometer device, specifically the detector device, through at least one optical interferometer;
b) determining for the plurality of photosensitive elements, specifically for each of the photosensitive elements, a plurality of detectors signals depending on the illumination through the optical interferometer in step a); and
c) determining at least one item of calibration information from the plurality of detector signals.

Embodiment 2: The method according to the preceding embodiment, wherein the optical interferometer is selected from the group consisting of: a Michelson interferometer; a Fabry-Pérot interferometer; a cube corner interferometer.

Embodiment 3: The method according to any one of the preceding embodiments, wherein in step a), a transmission frequency of the optical interferometer is varied over a predetermined spectral range, and wherein, in step b), the plurality of detectors signals is determined depending on the transmission frequency of the optical interferometer.

Embodiment 4: The method according to the preceding embodiment, wherein, in step c), the at least one item of calibration information is determined by comparing the transmission frequency of the optical interferometer with at least one of a pixel position and an identification number of the plurality of photosensitive elements generating intensity peaks in the plurality of detector signals associated with the transmission frequency.

Embodiment 5: The method according to any one of the preceding embodiments, wherein the optical interferometer comprises at least one beam splitting device for splitting incident light, specifically incident light from the broadband light source, into at least two illumination paths, wherein the optical interferometer further comprises at least one scanning mirror in a first illumination path and at least one stationary mirror in a second illumination path, wherein, in the method, specifically in step a), the scanning mirror is moved along the first illumination path, wherein the stationary mirror is kept stationary.

Embodiment 6: The method according to the preceding embodiment, wherein the scanning mirror is moved in a stepwise manner with a stepping frequency of 1 kHz or less, specifically with a stepping frequency of 500 Hz or less, more specifically with a stepping frequency of 150 Hz or less.

Embodiment 7: The method according to any one of the two preceding embodiments, wherein in step b), the plurality of detector signals is determined for a plurality of positions of the scanning mirror in the first illumination path, wherein the plurality of positions of the scanning mirror are different from each other.

Embodiment 8: The method according to the preceding embodiment, wherein step c) comprises, specifically prior to processing the plurality of detector signals, correlating the plurality of detector signals with the plurality of positions of the scanning mirror.

Embodiment 9: The method according to the preceding embodiment, wherein, in step c), the plurality of detector signals correlated to the plurality of positions of the scanning mirror is used for determining the at least one item of calibration information.

Embodiment 10: The method according to any one of the preceding embodiments, wherein step c) comprises processing the plurality of detector signals determined in the step b), thereby obtaining a plurality of processed detector signals, wherein the determining of the at least one item of calibration information in step c) comprises determining the at least one item of calibration information from the plurality of processed detector signals.

Embodiment 11: The method according to the preceding embodiment, wherein the processing of the plurality of detector signals comprises transforming, specifically mathematically transforming, the plurality of detector signals.

Embodiment 12: The method according to the preceding embodiment, wherein the plurality of detector signals is transformed by using at least one Fourier transformation, specifically at least one discrete Fourier transformation.

Embodiment 13: The method according to any one of the preceding embodiments, wherein the plurality of detector signals is recorded for a wavenumber in the range from 12.000 1/cm to 500 1/cm, specifically in the range from 10.000 1/cm to 1000 1/cm, more specifically in the range from 7.000 1/cm to 4.000 1/cm.

Embodiment 14: The method according to anyone of the preceding embodiments, wherein the item of calibration information comprises at least one of an item of wavelength calibration information and an item of stray light calibration information.

Embodiment 15: The method according to the preceding embodiment, wherein the item of wavelength calibration information comprises at least one wavelength calibration function, wherein the wavelength calibration function assigns at least one of a pixel position and an identification number of the photosensitive elements to a wavelength position.

Embodiment 16: The method according to any one of the two preceding embodiments, wherein the item of stray light calibration information comprises at least one signal distribution function, specifically at least one signal distribution matrix, wherein the signal distribution function describes a distribution of responses of the plurality of photosensitive elements, specifically a distribution of response of each photosensitive element, to incident light having a specific wavelength.

Embodiment 17: The method according to anyone of the preceding embodiments, wherein the method, specifically step c), is at least partially computer-implemented.

Embodiment 18: A system for calibrating a spectrometer device, wherein the system comprises the spectrometer device comprising at least one detector device, wherein the detector device comprises at least one optical element configured for separating incident light into a spectrum of constituent wavelength components and further comprising a plurality of photosensitive elements, wherein each photosensitive element is configured for receiving at least a portion of one of the constituent wavelength components and for generating a respective detector signal depending on an illumination of the respective photosensitive element by the at least one portion of the respective constituent wavelength component, the system further comprises at least one broadband light source and at least one optical interferometer arranged to illuminate the spectrometer device, specifically the detector device, with the broadband light source through the optical interferometer, wherein the system further comprises at least one evaluation unit, wherein the evaluation unit is configured for performing the method according to any one of the preceding embodiments.

Embodiment 19: The system according to the preceding embodiment, wherein the broadband light source comprises at least one of: an incandescent lamp; a blackbody radiator; an electric filament; a light emitting diode.

Embodiment 20: The system according to any one of the two preceding embodiments, wherein the optical element comprises at least one wavelength selective element.

Embodiment 21: The system according to the preceding embodiment, wherein the wavelength selective element is selected from the group consisting of: a prism; a grating; a linear variable filter; an optical filter, specifically a narrow band pass filter.

Embodiment 22: The system according to any one of the four preceding embodiments, wherein the detector device comprises the plurality of photosensitive elements arranged in a linear array, wherein the linear array of photosensitive elements comprises a number of 10 to 1000 photosensitive elements, specifically a number of 100 to 500 photosensitive elements, specifically a number of 200 to 300 photosensitive elements, more specifically a number of 256 photosensitive elements.

Embodiment 23: The system according to any one of the five preceding embodiments, wherein each photosensitive element is selected from the group consisting of: a pixelated inorganic camera element, specifically a pixelated inorganic camera chip, more specifically a CCD chip or a CMOS chip; a monochrome camera element, specifically a monochrome camera chip; at least one photoconductor, specifically an inorganic photoconductor, more specifically an inorganic photoconductor comprising PbS, PbSe, Ge, InGaAs, ext. InGaAs, InSb or HgCdTe.

Embodiment 24: The system according to any one of the six preceding embodiments, wherein each photosensitive element is sensitive for electromagnetic radiation in wavelength range from 760 nm to 1000 μm, specifically in a wavelength range from 760 nm to 15 μm, more specifically in a wavelength range from 1 μm to 5 μm, more specifically in a wavelength range from 1 μm to 3 μm.

Embodiment 25: The system according to any one of the seven preceding embodiments, wherein the detector device is comprised by the spectrometer device, specifically by at least one of a reflection spectrometer device and a transmission spectrometer device.

Embodiment 26: A computer program comprising instructions which, when the program is executed by the system according to any one of the preceding embodiments referring to a system, cause the evaluation unit of the system to perform the method for calibrating a spectrometer device according to any one of the preceding embodiments referring to a method.

Embodiment 27: A computer-readable storage medium comprising instructions which, when the program is executed by the system according to any one of the preceding embodiments referring to a system, cause the evaluation unit of the system to perform the method for calibrating a spectrometer device according to any one of the preceding embodiments referring to a method.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows an embodiment of a system for calibrating a spectrometer device in a schematic view;

FIG. 2 shows a flow chart of an embodiment of a method for calibrating a spectrometer device; and

FIG. 3A to 3D show diagrams of the stray light calibration.

### DETAILED DESCRIPTION OF THE EMBODIMENTS

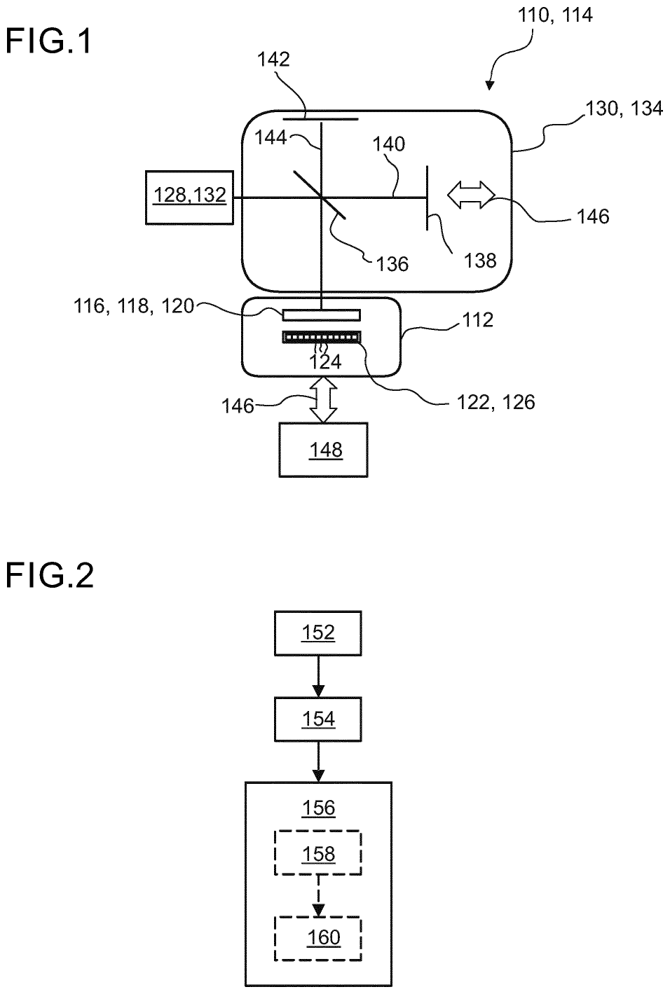

FIG. 1 shows an exemplary embodiment of a system 110 for calibrating a spectrometer device 114 in a schematic view. The system 110 comprises the spectrometer device 114 comprising at least one detector device 112. The detector device 112 comprises at least one optical element 116 configured for separating incident light into a spectrum of constituent wavelength components. The optical element 116 may specifically comprise at least one wavelength selective element 118. In the exemplary embodiment shown in FIG. 1, the wavelength selective element 118 may be a linear variable filter 120. However, other options, such as a prism, a grating, an optical filter, specifically a narrow band pass filter, are also feasible.

The detector device 112 further comprises a plurality of photosensitive elements 122, wherein each photosensitive element 124 is configured for receiving at least a portion of one of the constituent wavelength components and for generating a respective detector signal depending on an illumination of the respective photosensitive element 124 by the at least one portion of the respective constituent wavelength component.

As can be seen in FIG. 1, the detector device 112 may comprise the plurality of photosensitive elements 122 arranged in a linear array 126. The linear array 126 of photosensitive elements 124 may comprise a number of 256 photosensitive elements 124. Each photosensitive element 124 may be an inorganic photoconductor comprising PbS. However, other numbers or sizes of linear arrays and/or other photoconductors are also feasible. Each photosensitive element 124 may be sensitive for electromagnetic radiation in wavelength range from 1 μm to 3 μm.

The system 110 further comprises at least one broadband light source 128 and at least one optical interferometer 130 arranged to illuminate the detector device 112 with the broadband light source 128 through the optical interferometer 130. The broadband light source 128 may, as an example, comprise at least one incandescent lamp 132. However, other broadband light sources 128, such as a blackbody radiator, a light emitting diode and/or an electric filament, are also feasible.

As shown in FIG. 1, the optical interferometer 130 may comprise at least one Michelson interferometer 134. However, other optical interferometer, such as a Fabry-Pérot interferometer and/or a cube corner interferometer, are also feasible, in principle. In this example, the optical interferometer 130 may comprise at least one beam splitting device 136 for splitting incident light, specifically incident light from the broadband light source 128, into at least two illumination paths. The optical interferometer 130 may further comprise at least one scanning mirror 138 in a first illumination path 140 and at least one stationary mirror 142 in a second illumination path 144. As indicated by arrow 146, the scanning mirror 138 may be movable along the first illumination path 140.

The system 110 further comprises at least one evaluation unit 148, wherein the evaluation unit is configured for performing a method for calibrating a spectrometer device 114 according to the present invention, such as according to any one of the embodiments disclosed above and/or any one of the embodiments disclosed in further detail below. The evaluation unit 148 may be configured for, unidirectionally and/or bidirectionally, exchanging data and/or control commands with other elements of the system 110, specifically with the detector device 112, as indicated by arrow 150 in FIG. 1. Specifically, the evaluation unit 148 may be configured for receiving the plurality of detector signals from the detector device 112.

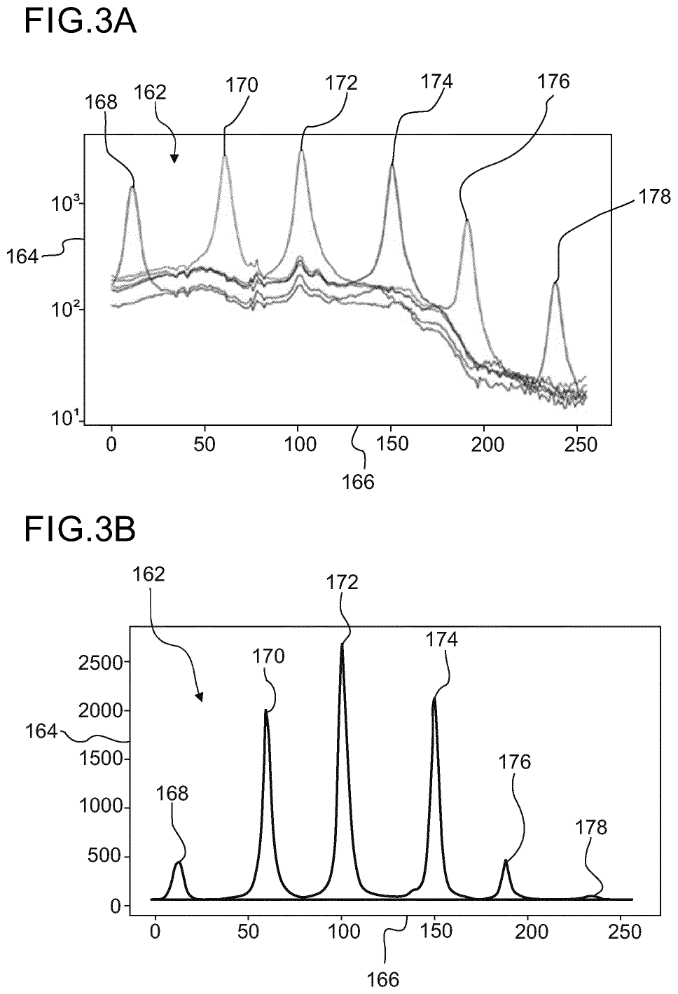

In FIG. 2, a flow chart of an exemplary embodiment of a method for calibrating a spectrometer device 114 is shown. The spectrometer device 114 may be embodied as shown in FIG. 1: The spectrometer device 114 comprises the at least one detector device 112 comprising the at least one optical element 116 configured for separating incident light into the spectrum of constituent wavelength components. The detector device 112 further comprises the plurality of photosensitive elements 122, wherein each photosensitive element 124 is configured for receiving at least a portion of one of the constituent wavelength components and for generating a respective detector signal depending on the illumination of the respective photosensitive element 124 by the at least one portion of the respective constituent wavelength component.

The method comprises the following steps which, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises the following steps:
a) (denoted by reference number 152) illuminating, by using the at least one broadband light source 128, the spectrometer device 114, specifically the detector device 112, through the at least one optical interferometer 130;
b) (denoted by reference number 154) determining for the plurality of photosensitive elements 122, specifically for each of the photosensitive elements 124, a plurality of detectors signals depending on the illumination through the optical interferometer 130 in step a); and
c) (denoted by reference number 156) determining at least one item of calibration information from the plurality of detector signals.

Further, in step a), a transmission frequency of the optical interferometer 130 may be varied over a predetermined spectral range, and wherein, in step b), the plurality of detectors signals may be determined depending on the transmission frequency of the optical interferometer 130. In step c), the at least one item of calibration information may be determined by comparing the transmission frequency of the optical interferometer 130 with at least one of a pixel position and an identification number of the plurality of photosensitive elements 122 generating intensity peaks in the plurality of detector signals associated with the transmission frequency.

As outlined above, the optical interferometer 130 may comprise the at least one scanning mirror 138 in the first illumination path 140 and the at least one stationary mirror 142 in the second illumination path 144. The scanning mirror 138 may be movable along the first illumination path 140. In the method, specifically in step a), the scanning mirror 138 may be moved along the first illumination path 144, wherein the stationary mirror 142 may be kept stationary. The scanning mirror 138 may be moved in a stepwise manner with a stepping frequency of 1 kHz or less, specifically with a stepping frequency of 100 Hz or less, more specifically with a stepping frequency of 10 Hz or less.

Further, in step b), the plurality of detector signals may be determined for a plurality of positions of the scanning mirror 138 in the first illumination path 140. The plurality of positions of the scanning mirror 138 may be different from each other. Additionally, as shown in FIG. 2, step c) may comprise, specifically prior to processing the plurality of detector signals, correlating the plurality of detector signals with the plurality of positions of the scanning mirror 138 (denoted by reference number 158). Thus, in step c), the plurality of detector signals correlated to the plurality of positions of the scanning mirror 138 may be used for determining the at least one item of calibration information.

Additionally, as shown in FIG. 2, step c) may comprise processing the plurality of detector signals determined in the step b), thereby obtaining a plurality of processed detector signals (denoted by reference number 160). The determining of the at least one item of calibration information in step c) may comprise determining the at least one item of calibration information from the plurality of processed detector signals. Specifically, the processing of the plurality of detector signals may comprise transforming, specifically mathematically transforming, the plurality of detector signals. For example, the plurality of detector signals may be transformed by using at least one Fourier transformation, specifically at least one discrete Fourier transformation.

The item of calibration information may comprise at least one of an item of wavelength calibration information and an item of stray light calibration information. The item of wavelength calibration information may comprise at least one wavelength calibration function. The wavelength calibration function may assign at least one of the pixel position and the identification number of the photosensitive elements 124 to a wavelength position. For example, the wavelength calibration function may comprise a polynomial function. However, other wavelength calibration functions are also feasible. The item of stray light calibration information may comprise at least one signal distribution function, specifically at least one signal distribution matrix. The signal distribution function may describe a distribution of responses of the plurality of photosensitive elements 122, specifically a distribution of response of each photosensitive element 124, to incident light having a specific wavelength. By way of example, computation and/or application of the signal distribution matrix may be described in further detail in Y. Zong, S. W. Brown, B. C. Johnson, K. R. Lykke and Y. Ohno: “Simple spectral stray light correction method for array spectroradiometers”, Applied Optics, volume 45, number 6, 2006.

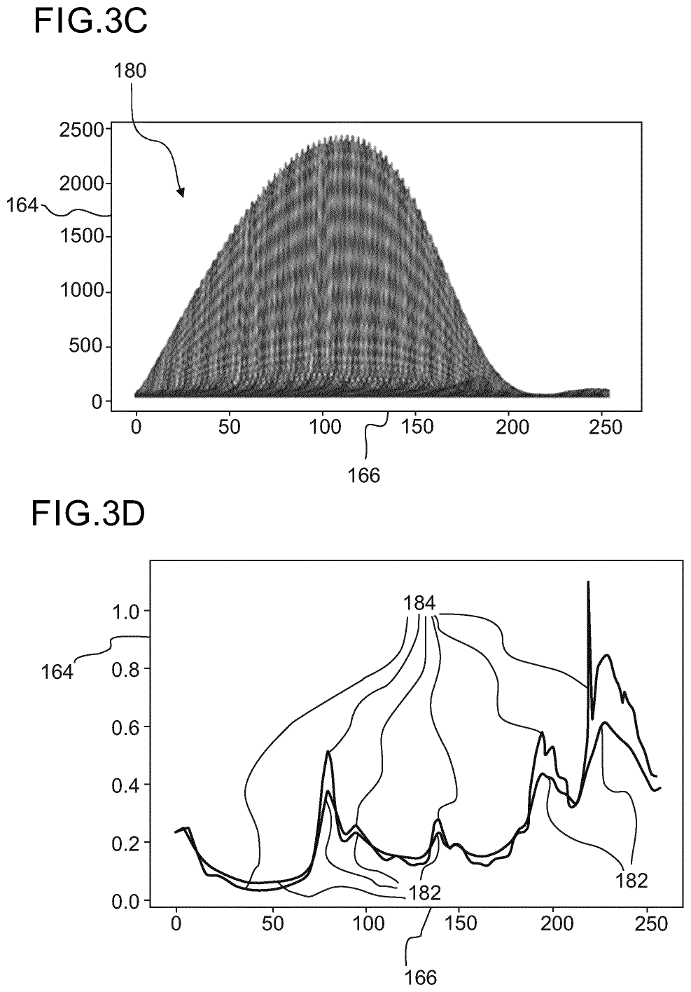

Diagrams of the stray light calibration, specifically corresponding to a plurality of sub-steps for determining the item of stray light calibration information, are shown in FIGS. 3A to 3D. In FIG. 3A, the plurality of processed detector signals 162 for different transmission frequencies of the optical interferometer 130 is shown. Specifically, in the diagram of FIG. 3A, a signal intensity 164 of the processed detector signals is shown as a function of the pixel position 166 of the plurality of photosensitive elements 122. FIG. 3A shows the plurality of processed detector signals 162 for some transmission frequencies of the optical interferometer 130, specifically corresponding to a transmission wavelength of 1456 nm (denoted by reference number 168), to a transmission wavelength of 1664 nm (denoted by reference number 170), to a transmission wavelength of 1840 nm (denoted by reference number 172), to a transmission wavelength of 2057 nm (denoted by reference number 174), to a transmission wavelength of 2241 nm (denoted by reference number 176) and to a transmission wavelength of 2446 nm (denoted by reference number 178).

The processing of the plurality of detector signals may comprise applying one or more of an offset correction and a digital filter to the plurality of detector signals. FIG. 3B shows the plurality of processed detector signals 162 after application of an offset correction and a digital filter, such as a Savitzky-Golay filter. Specifically, in the diagram of FIG. 3B, a signal intensity 164 of the processed detector signals is shown as a function of the pixel position 166 of the plurality of photosensitive elements 122. In FIG. 3B, the signal intensities 164 for the transmission frequencies as identified in FIG. 3A are shown. A signal intensity 164 of transmission frequencies corresponding to transmission wavelengths in the range of from 1456 nm to 2446 nm (denoted by reference number 180) are shown in FIG. 3C. The values of those signal intensities may be stored in a so-called signal distribution matrix.

The signal distribution matrix, specifically an inverse of the signal distribution matrix, may be applied to a measurement spectrum determined with the calibrated detector device 112. The effect of applying the signal distribution matrix on a measurement spectrum is shown in FIG. 3D. In the diagram of FIG. 3D, a relative intensity of the measurement spectrum is shown as a function of the pixel position 166. In FIG. 3D, an uncorrected measurement spectrum 182 of a PET sample and the corresponding corrected measurement spectrum 184 obtained by applying the item of stray light calibration information, specifically comprising the signal distribution matrix, to the uncorrected measurement spectrum 182 is shown. As can be seen in FIG. 3D, applying of the item of stray light calibration information may increase the spectral resolution and reduce the influence of stray light.

### LIST OF REFERENCE NUMBERS

110 system
112 detector device
114 spectrometer device
116 optical element
118 wavelength selective element
120 linear variable filter
122 plurality of photosensitive elements
124 photosensitive element
126 linear array
128 broadband light source
130 optical interferometer
132 incandescent lamp
134 Michelson interferometer
136 beam splitting device
138 scanning mirror
140 first illumination path
142 stationary mirror
144 second illumination path
146 arrow
148 evaluation unit
150 arrow
152 illuminating the detector device
154 determining a plurality of detectors signals
156 determining at least one item of calibration information
158 correlating the plurality of detector signals
160 processing the plurality of detector signals
162 plurality of processed detector signals
164 signal intensity
166 pixel position
168 transmission wavelength of 1456 nm
170 transmission wavelength of 1664 nm
172 transmission wavelength of 1840 nm
174 transmission wavelength of 2057 nm
176 transmission wavelength of 2241 nm
178 transmission wavelength of 2446 nm
180 transmission wavelengths in the range of from 1456 nm to 2446 nm
182 uncorrected measurement spectrum
184 corrected measurement spectrum

1. A method for calibrating a spectrometer device, wherein the spectrometer device comprises at least one detector device comprising at least one optical element configured for separating incident light into a spectrum of constituent wavelength components and further comprising a plurality of photosensitive elements, wherein each photosensitive element is configured for receiving at least a portion of one of the constituent wavelength components and for generating a respective detector signal depending on an illumination of the respective photosensitive element by the at least one portion of the respective constituent wavelength component, wherein the method comprises the following steps:
a) illuminating, by using at least one broadband light source, the spectrometer device through at least one optical interferometer;
b) determining for the plurality of photosensitive elements a plurality of detectors signals depending on the illumination through the optical interferometer in step a); and
c) determining at least one item of calibration information from the plurality of detector signals;
wherein the optical interferometer comprises at least one beam splitting device for splitting incident light into at least two illumination paths, wherein the optical interferometer further comprises at least one scanning mirror in a first illumination path and at least one stationary mirror in a second illumination path, wherein, in the method, the scanning mirror is moved along the first illumination path, wherein the stationary mirror is kept stationary, wherein the scanning mirror is moved in a stepwise manner with a stepping frequency of 1 kHz or less, wherein the stepping frequency of the scanning mirror is slower than a maximum readout frequency of the detector device.

2. The method according to claim 1, wherein the optical interferometer is selected from the group consisting of a Michelson interferometer; a Fabry-Pérot interferometer; and a cube corner interferometer.

3. The method according to claim 1, wherein in step a), a transmission frequency of the optical interferometer is varied over a predetermined spectral range, and wherein, in step b), the plurality of detectors signals is determined depending on the transmission frequency of the optical interferometer.

4. The method according to claim 3, wherein, in step c), the at least one item of calibration information is determined by comparing the transmission frequency of the optical interferometer with at least one of a pixel position and an identification number of the plurality of photosensitive elements generating intensity peaks in the plurality of detector signals associated with the transmission frequency.

5. The method according to claim 1, wherein in step b), the plurality of detector signals is determined for a plurality of positions of the scanning mirror in the first illumination path, wherein the plurality of positions of the scanning mirror are different from each other, wherein step c) comprises correlating the plurality of detector signals with the plurality of positions of the scanning mirror, wherein, in step c), the plurality of detector signals correlated to the plurality of positions of the scanning mirror is used for determining the at least one item of calibration information.

6. The method according to claim 1, wherein step c) comprises processing the plurality of detector signals determined in the step b), thereby obtaining a plurality of processed detector signals, wherein the determining of the at least one item of calibration information in step c) comprises determining the at least one item of calibration information from the plurality of processed detector signals, wherein the processing of the plurality of detector signals comprises transforming the plurality of detector signals, wherein the plurality of detector signals is transformed by using at least one Fourier transformation.

7. The method according to claim 1, wherein the item of calibration information comprises at least one of an item of wavelength calibration information and an item of stray light calibration information.

8. The method according to claim 7, wherein the item of wavelength calibration information comprises at least one wavelength calibration function, wherein the wavelength calibration function assigns at least one of a pixel position and an identification number of the photosensitive elements to a wavelength position.

9. The method according to claim 7, wherein the item of stray light calibration information comprises at least one signal distribution function, wherein the signal distribution function describes a distribution of responses of the plurality of photosensitive elements to incident light having a specific wavelength.

10. A system for calibrating a spectrometer device, wherein the system comprises the spectrometer device comprising at least one detector device, wherein the detector device comprises at least one optical element configured for separating incident light into a spectrum of constituent wavelength components and further comprising a plurality of photosensitive elements, wherein each photosensitive element is configured for receiving at least a portion of one of the constituent wavelength components and for generating a respective detector signal depending on an illumination of the respective photosensitive element by the at least one portion of the respective constituent wavelength component, wherein the system further comprises at least one broadband light source and at least one optical interferometer arranged to illuminate the spectrometer device with the broadband light source through the optical interferometer, wherein the system further comprises at least one evaluation unit, wherein the evaluation unit is configured for performing the method according to claim 1.

11. The system according to claim 10, wherein the broadband light source comprises at least one of an incandescent lamp; a blackbody radiator; an electric filament; or a light emitting diode.

12. The system according to claim 10, wherein the optical element comprises at least one wavelength selective element, wherein the wavelength selective element is selected from the group consisting of a prism; a grating; a linear variable filter; and an optical filter.

13. The system according to claim 10, wherein the detector device comprises the plurality of photosensitive elements arranged in a linear array, wherein the linear array of photosensitive elements comprises a number of 10 to 1000 photosensitive elements.

14. A computer program comprising instructions which, when the program is executed by the system according to claim 10, cause the evaluation unit of the system to perform the method for calibrating a spectrometer device.
